(19) United States
(12) Patent Application Publication
(10) Pub. No.: US 2006/0116074 A1
(43) Pub. Date: Jun. 1, 2006

(54) Communication repeater, communication repeater program, and communication repeater system

(75) Inventors: Shugo Kato, Yokohama-city (JP); Shigeki Kawai, Yokohama-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/232,336

(22) Filed: Sep. 21, 2005

(30) Foreign Application Priority Data
Sep. 30, 2004 (JP) 2004-286395

(51) Int. Cl. H04B 7/15

(52) U.S. Cl. 455/11.1

(57) ABSTRACT

A wireless base station and a wireless mobile station repeat, via a wireless communication section therebetween, transmission of contents data from a server to a terminal. Each of the wireless base station and the wireless mobile station periodically transmits camouflage data to each of the server and the terminal, respectively, when the wireless communication section is incommunicative. This causes each of the server and the terminal to determine that a connection for data communication between the server and the terminal is continuing. Processing for the transmission/reception in the data communication is thereby prevented from being interrupted even when a wireless communication environment deteriorates and the wireless communication section becomes incommunicative.

### CROSS REFERENCE TO RELATED APPLICATIONS

This application is based on and incorporates herein by reference Japanese Patent Application No. 2004-286395 filed on Sep. 30, 2004.

### FIELD OF THE INVENTION

The present invention relates to a technology for repeating data communication which is performed between communication units via a communication path having a wireless communication section in a part thereof.

### BACKGROUND OF THE INVENTION

Conventionally, data communication between communication units via a wireless communication section has been performed widely. Examples of such data communication include data exchange between personal computers via a wireless LAN line and music data download from a Web server on the Internet to a vehicle-mounted communication terminal.

In such data communication, when the wireless communication section comes into an incommunicable state due to the deterioration of a wireless communication environment and the transmission/reception of data between the communication units is not performed for a given period or longer, each of the communication units may close a connection for the data communication in the processing of an application (e.g., a http server or downloader) executed for the data communication. As a result, processing for the data communication is interrupted without completing the transmission/reception of data.

Once the processing for the data communication is thus interrupted, even when a communication environment recovers and communication between the communication units is enabled, the transmission/reception of data should occasionally be performed from the beginning, not from the point of interruption. Once the process of, e.g., downloading data is ended halfway due to the deterioration of the communication environment, communication should be started from the reestablishment of the connection when the communication environment has recovered. In addition, the downloading of data should be started from the beginning unless each of the transmitter and receiver of data has a special function such as a resume function.

### SUMMARY OF THE INVENTION

An object of the present invention is to solve the above problem. Namely, in data communication between communication units via a wireless communication section, the closing of a connection and the interruption of processing for data transmission/reception can be prevented even when a wireless communication environment deteriorates and the wireless communication section becomes incommunicative.

To achieve the above object, a communication repeater is provided with the following. A communication circuit is included. A repeating unit is included for repeating data communication between first and second communication units by using the communication circuit. Further, a transmission control unit is included for repetitively transmitting, to the first communication unit and by using the communication circuit, camouflage data for causing the first communication unit to determine that the data communication between the first and second communication units is continuing when communication is disabled in a wireless communication section between the second communication unit and the communication repeater to which the transmission control unit belongs.

In this arrangement, even when the wireless communication section between the communication repeater and the second communication unit is incommunicative, the camouflage data is repetitively transmitted from the communication repeater to the first communication unit. Accordingly, even when the wireless communication section is incommunicative, the first communication unit determines that data communication between the first and second communication units is continuing and does not interrupt processing for the data communication. More specifically, the processing for the data communication is maintained by designing an interval between the repetitive transmissions of the camouflage data to be not longer than a reference period. Here, when there is no data from the second communication unit for a period not shorter than the reference period, the first communication unit has been adapted to interrupt the processing for the data communication with the second communication unit.

Thus, in data communication between communication units via a wireless communication section, even when a wireless communication environment deteriorates and the wireless communication section becomes incommunicative, the present invention helps prevent processing for the transmission/reception of data from being interrupted.

### BRIEF DESCRIPTION OF THE DRAWINGS

The above and other objects, features, and advantages of the present invention will become more apparent from the following detailed description made with reference to the accompanying drawings. In the drawings:

FIG. 1 is a structural view of a communication repeater system according to an embodiment of the present invention;

FIG. 2 is a block diagram showing the hardware configuration of a server;

FIG. 3 is a block diagram showing the hardware configuration of a wireless base station;

FIG. 4 is a block diagram showing the hardware configuration of a wireless mobile station;

FIG. 5 is a block diagram showing the hardware configuration of a terminal;

FIG. 6 is a flow chart for a program 100 for downlink reception;

FIG. 7 is a flow chart for a program 200 for uplink transmission;

FIG. 8 is a flow chart for a program 300 for downlink transmission;

FIG. 9 is a flow chart for a program 400 for uplink transmission;

FIG. 10 is a flow chart for a program 500 for uplink reception;

FIG. 11 is a detailed flow chart for Step 160 in each of the program 100 for downlink reception and the program 500 for uplink reception; and

FIG. 12 is a flow chart for a program 600 for downlink transmission.

### DETAILED DESCRIPTION OF THE PREFERRED EMBODIMENTS

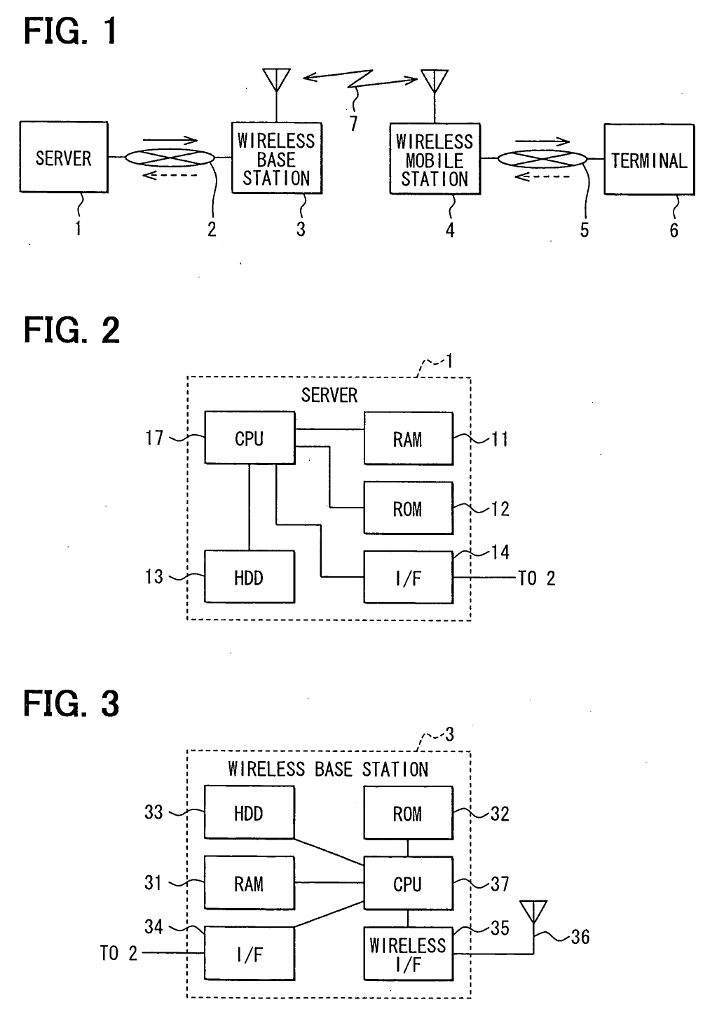

An embodiment of the present invention will be described herein below. FIG. 1 is an overall structural view of a communication repeater system according to the present invention. The communication repeater system has: a server 1; a wired network 2; a wireless base station 3; a wireless mobile station 4; a wired network 5; and a terminal 6. The server 1 and the wireless base station 3 are capable of data communication therebetween via a broadband network such as the Internet or the wired network 2 which is a LAN. The wireless mobile station 4 and the terminal 6 are capable of data communication therebetween via a broadband network such as the Internet or the wired network 5 which is a LAN. The wireless base station 3 and the wireless mobile station 4 are wirelessly connected to each other to be capable of data communication therebetween via a wireless communication section 7 established by the connection. In the data communication mentioned above, the present embodiment uses the TCP/IP protocols as communication protocols.

In the present embodiment, the server 1 and the terminal 6 establish a connection therebetween by data communication via the wired network 2, the wireless base station 3, the wireless communication section 7; the wireless mobile station 4; and the wired network 5. By using the connection, contents data such as image data, video data, music data, and a program is transmitted from the server 1 to the terminal 6. As the server 1, e.g., a personal computer for executing a http server application may be considered. As the terminal 6, e.g., a personal computer for executing a Web browser application for downloading contents data, a navigator for a vehicle, or the like may be considered.

At this time, the wireless base station 3 and the wireless mobile station 4 repeat the transmission of the contents data. In the present embodiment, when the wireless communication section 7 is incommunicative, the wireless base station 3 and the wireless mobile station 4 periodically transmit camouflage data for causing the server 1 and the terminal 6 to determine that the connection for data communication therebetween is continuing to the server 1 and the terminal 6.

FIGS. 2 to 5 are block diagrams showing the hardware configuration of the server 1, the wireless base station 3, the wireless mobile station 4, and the terminal 6.

FIG. 2 is a block diagram of the server 1. The server 1 has: a RAM 11; a ROM 12; a HDD (Hard Disk Drive) 13; a network interface (denoted as Network I/F in the drawing) 14; and a CPU 17.

The network interface 14 receives data sent out from the wireless base station 3 onto the wired network 2 to be delivered to the server 1, converts the data to a format recognizable by the CPU 17, and outputs the converted data to the CPU 17. The network interface 14 also processes data received from the CPU 17 to be delivered to the terminal 6 as the final destination via the wireless base station 3 such that it conforms to the TCP/IP communication protocols and sends out the processed data to the wired network 2.

The CPU 17 executes a program for the operation of the server 1 that has been read from the ROM 12 and the HDD 13, reads information from the RAM 11, ROM 12, or HDD 13 upon the execution thereof when it is necessary, writes information in the RAM 11 or HDD 13, and performs the transmission/reception of communication data to and from the network interface 14.

The following is an operation performed through the execution of the program by the CPU 17 in the present embodiment. That is, the CPU 17 reads, from the HDD 13, contents data to be transmitted to the terminal 6, divides the contents data into multiple packets (more specifically, IP datagrams) each having information designating the terminal 6 as the final destination and designating the wireless base station 3 as a via-point, and outputs the packets to the network interface 14.

When the CPU 17 divides the contents data into the packets and outputs the packets to the network interface 14, it adds a sequence number to each of the packets. The sequence number indicates the position (specifically, a number of order in bytes) in the contents data from which the data in the packet has come.

However, in the contents data to be transmitted, the data outputted from the CPU 17 to the network interface 14 is restricted by ACK data (corresponding to response data) from the wireless base station 3. Specifically, upon receipt of the ACK data from the wireless base station 3 that has been received by the network interface 14, the CPU 17 adds an allowable buffer size (more specifically, a window size) contained in the ACK to an ACK number similarly contained in the ACK. Then, the CPU 17 outputs, to the network interface 14, a sequence of data from data at a position next to the position corresponding to the ACK number in the contents data to be transmitted through data on a value (in the unit of, e.g., bytes) resulting from the addition. The transmission of data subsequent thereto is awaited till ACK data is newly received from the wireless base station 3.

When the CPU 17 has not received ACK data from the wireless base station 3 for a given period (e.g., 10 minutes), it determines that connection with the terminal 6 has been closed and ends the process of transmitting contents data to be transmitted.

The operation of the CPU 17 described above conforms to normal TCP protocols.

FIG. 3 is a block diagram of the wireless base station 3. The wireless base station 3 has: a RAM 31; a ROM 32; a HDD 33; a network interface (denoted as Network I/F in the drawing) 34; a wireless interface (denoted as Wireless I/F in the drawing) 35; an antenna 36; and a CPU 37 (corresponding to a computer).

The network interface 34 receives data transmitted from the server 1 to the wired network 2 and designating the wireless base station 3 as a via-point, converts the received data to a format recognizable by the CPU 37, and outputs the converted data to the CPU 37. The network interface 34 also processes data received from the CPU 37 and designating the server 1 as the destination such that it conforms to the TCP/IP communication protocols and sends out the processed data to the wired network 2.

The wireless interface 35 performs frequency conversion, demodulation, amplification, A/D conversion, and the like in accordance with specified wireless communication protocols and the TCP/IP protocols with respect to a signal received from the antenna 36 and outputs the resulting data to the CPU 37. The wireless interface 35 also performs D/A conversion, amplification, modulation, frequency conversion, and the like in accordance with the specified wireless communication protocols and the TCP/IP protocols with respect to data received from the CPU 37 and outputs the resulting signal to the antenna 36 such that it is delivered to the wireless mobile station 4. In addition, the wireless interface 35 specifies the reception power level of a signal from the wireless mobile station 4 and outputs a reception level signal indicating the reception power level to the CPU 37.

The CPU 37 executes a program for the operation of the wireless base station 3 that has been read from the ROM 32 and the HDD 33. Upon the execution thereof, the CPU 37 reads information from the RAM 31, ROM 32, or HDD 33 when it is necessary, writes information in the RAM 31 or HDD 33, and performs the transmission/reception of communication data to and from the network interface 34 and the wireless interface 35. The specific operation of the CPU 37 will be described later.

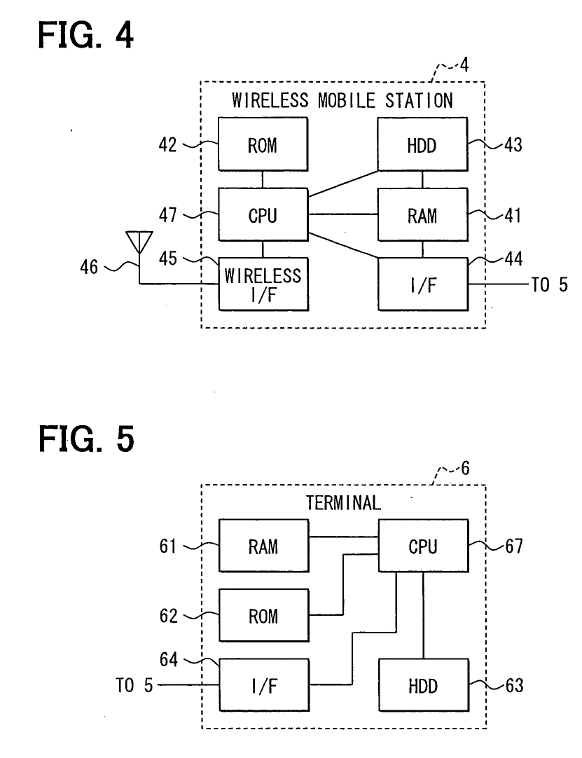

FIG. 4 is a block diagram of the wireless mobile station 4. The wireless mobile station 4 has: a RAM 41; a ROM 42; a HDD 43; a network interface (denoted as Network I/F in the drawing) 44; a wireless interface (denoted as Wireless I/F in the drawing) 45; an antenna 46; and a CPU 47 (corresponding to a computer).

The network interface 44 receives data sent out from the terminal 6 to the wired network 5 and designating the wireless mobile station 4 as a via-point, converts the received data to a format recognizable by the CPU 47, and outputs the converted data to the CPU 47. The network interface 44 also processes data received from the CPU 47 and designating the terminal 6 as the destination such that it conforms to the TCP/IP communication protocols and sends out the processed data to the wired network 5.

The wireless interface 45 performs frequency conversion, demodulation, amplification, A/D conversion, and the like in accordance with specified wireless communication protocols and the TCP/IP protocols with respect to a signal received from the antenna 46 and outputs the resulting data to the CPU 47. The wireless interface 45 also performs D/A conversion, amplification, modulation, frequency conversion, and the like in accordance with the specified wireless communication protocols and the TCP/IP protocols with respect to data received from the CPU 47 and outputs the resulting signal to the antenna 46 such that it is delivered to the wireless base station 3. In addition, the wireless interface 45 specifies the reception power level of a signal from the wireless base station 3 and outputs a reception level signal indicating the reception power level to the CPU 47.

The CPU 47 executes a program for the operation of the wireless mobile station 4 that has been read from the ROM 42 and the HDD 43. Upon the execution thereof, the CPU 47 reads information from the RAM 41, ROM 42, or HDD 43 when it is necessary, writes information in the RAM 41 or HDD 43, and performs the transmission/reception of communication data to and from the network interface 44 and the wireless interface 45. The specific operation of the CPU 47 will be described later.

FIG. 5 is a block diagram of the terminal 6. The terminal 6 has: a RAM 61; a ROM 62; a HDD 63; a network interface (denoted as Network I/F in the drawing) 64; and a CPU 67.

The network interface 64 receives data sent out from the wireless base station 4 to the wired network 5 and designating the terminal 6 as the destination, converts the received data to a format recognizable by the CPU 67, and outputs the converted data to the CPU 67. The network interface 64 also processes data received from the CPU 67, designating the server 1 as the final destination, and designating the wireless mobile station 4 as a via-point such that it conforms to the TCP/IP communication protocols and sends out the processed data to the wired network 5.

The CPU 67 executes a program for the operation of the terminal 6 that has been read from the ROM 62 and the HDD 63. Upon the execution thereof, the CPU 67 reads information from the RAM 61, ROM 62, or HDD 63 when it is necessary, writes information in the RAM 61 or HDD 63, and performs the transmission/reception of communication data to and from the network interface 64.

The following is an operation performed through the execution of the program by the CPU 67 in the present embodiment. That is, upon receipt of contents data that has been transmitted from the server 1 as the initial transmitter, transmitted from the wireless mobile station 4 to the terminal 6, and received by the network interface 64, the CPU 67 stores the contents data in the RAM 61 or HDD 13. When the CPU 67 has not received a packet of contents data from the current server 1 for a specified period (e.g., 10 minutes) or longer, it determines that the connection with the server 1 has been closed and ends the process of receiving the contents data.

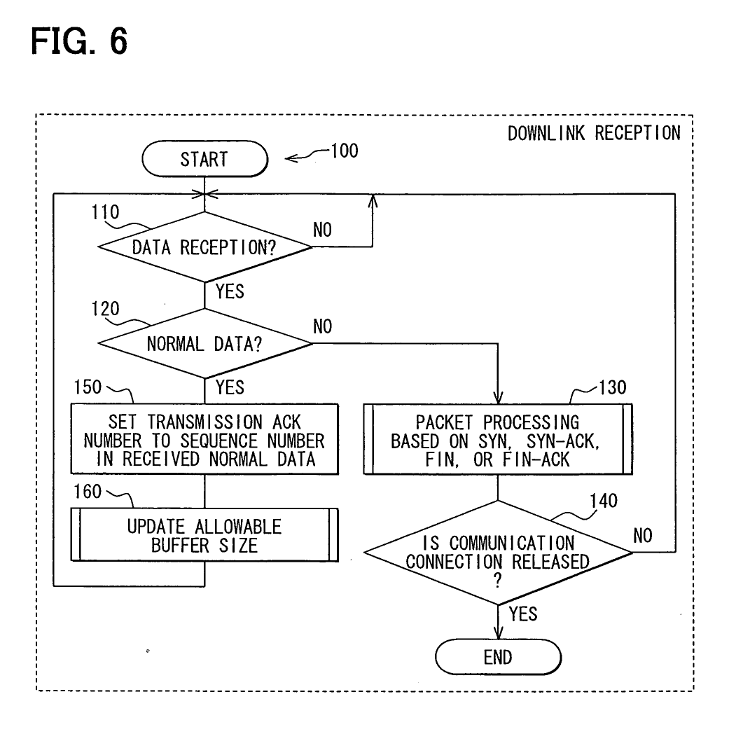

A description will be given next to a process for repeating contents data transmitted from the server 1 to the terminal 6, which is performed by the wireless base station 3 and the wireless mobile station 4. FIGS. 6 to 12 are flow charts for a program which is executed for the process by the CPU 37 at the wireless base station 3 or by the CPU 47 at the wireless mobile station 4.

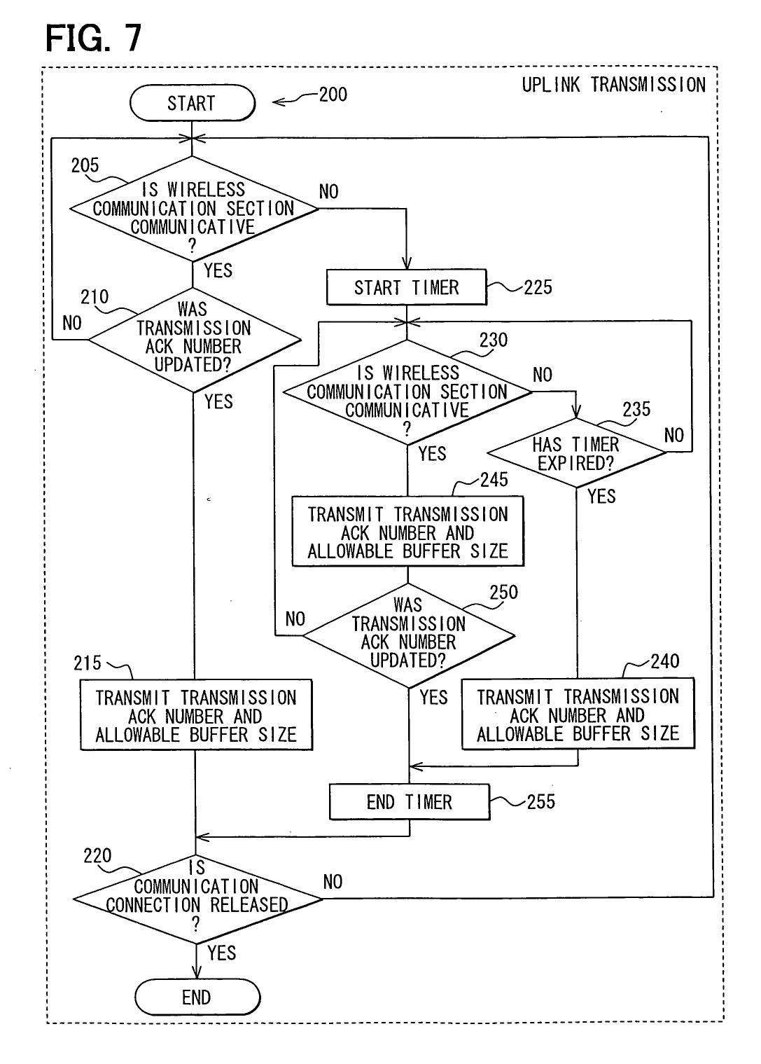

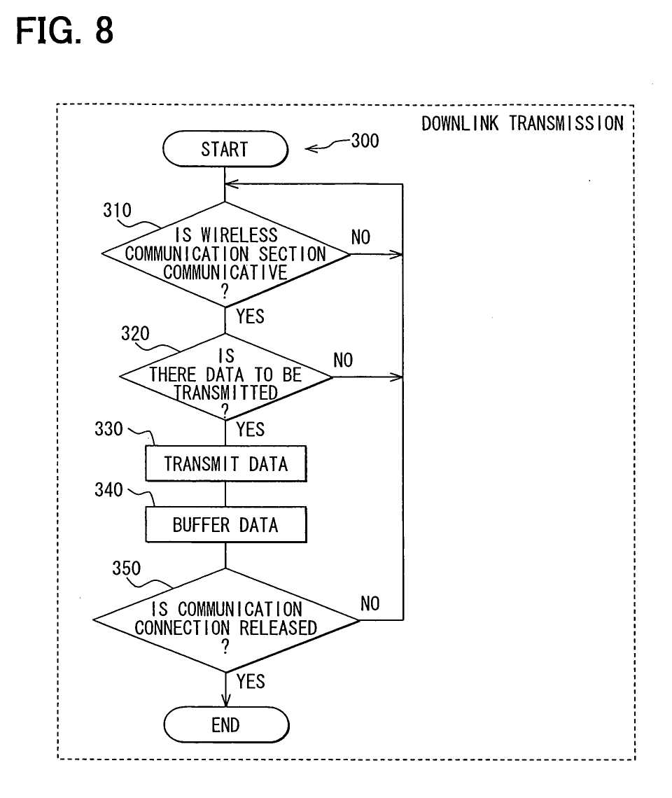

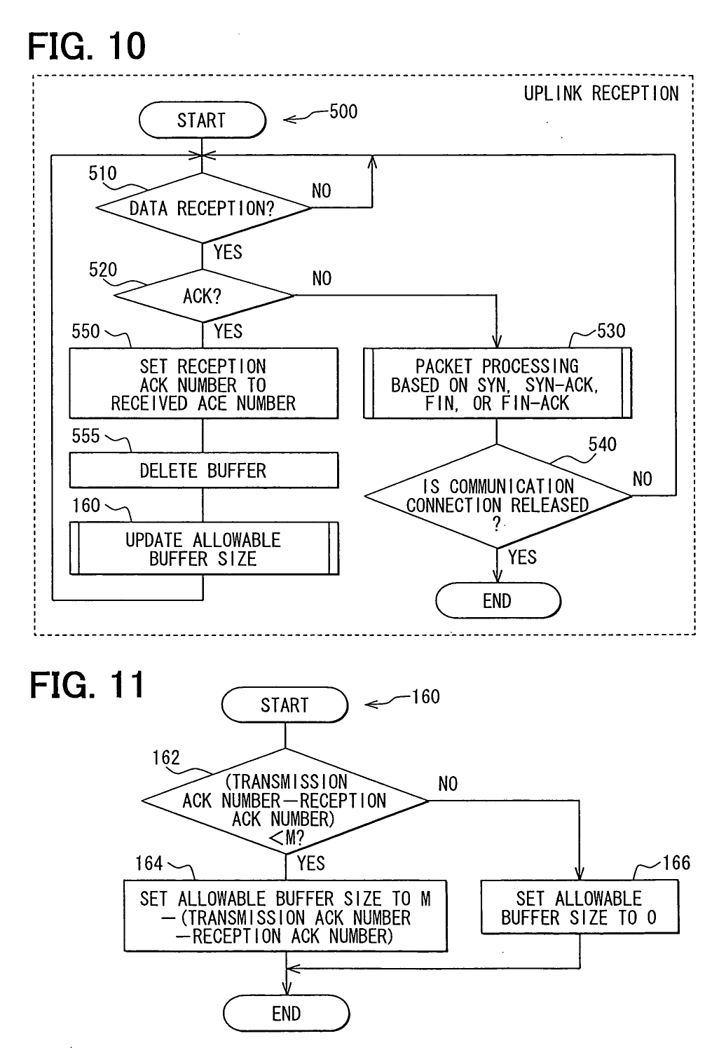

The CPU 37 constantly executes in parallel a program 100 for downlink reception of FIG. 6, a program 200 for uplink transmission of FIG. 7, a program 300 for downlink transmission of FIG. 8, and a program 500 for uplink reception of FIG. 10, while the connection with the terminal 6 is continuing.

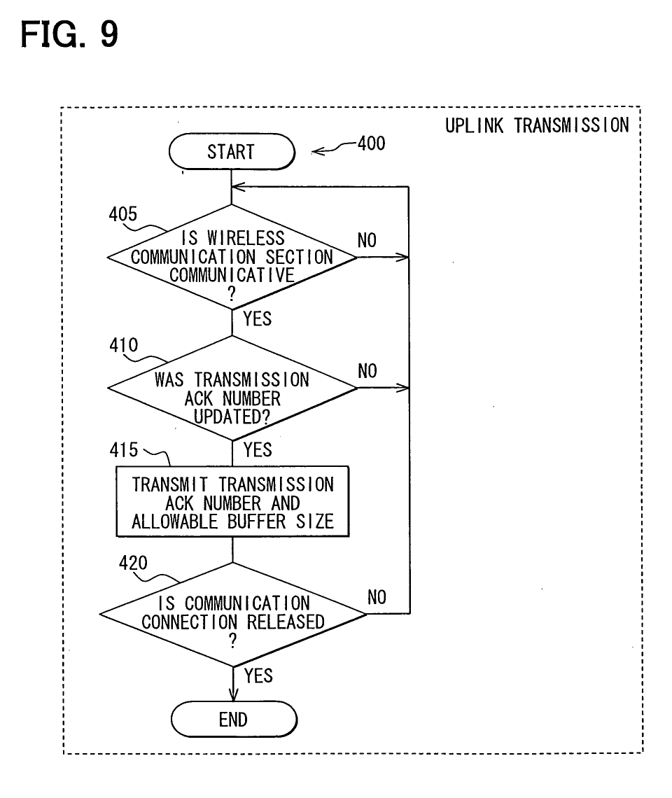

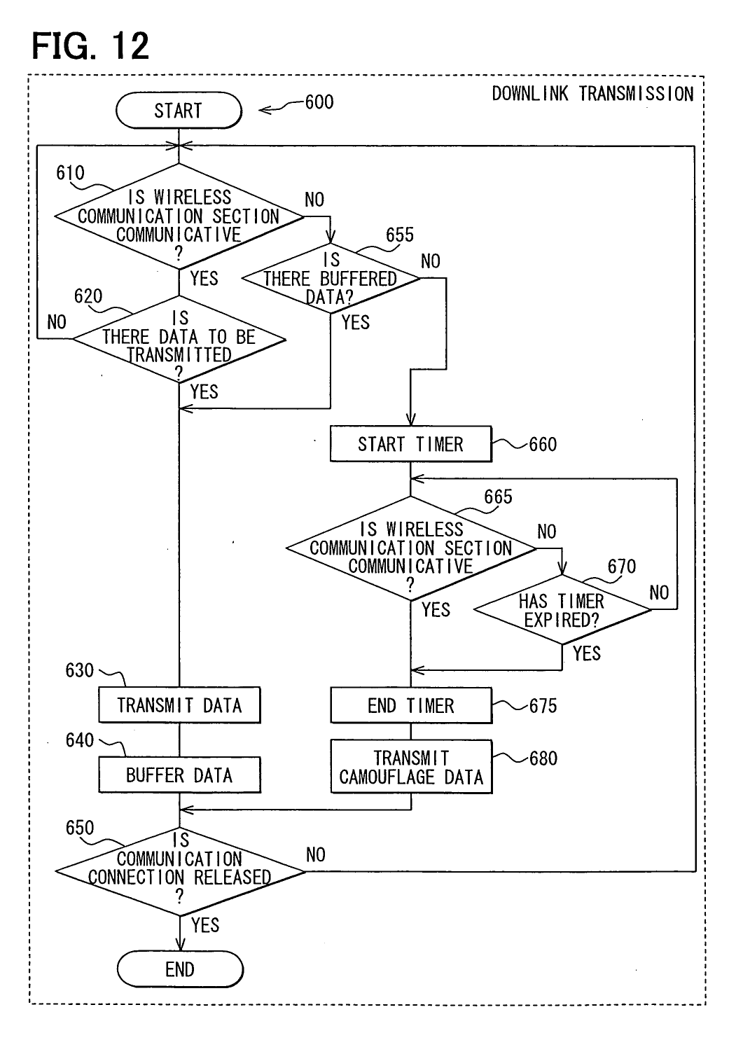

The CPU 47 constantly executes in parallel the program 100 for downlink reception of FIG. 6, a program 400 for uplink transmission of FIG. 9, the program 500 for uplink reception of FIG. 10, and a program 600 for downlink transmission of FIG. 12, while the connection with the server 1 is continuing.

The operation of each of the CPU 37 and the CPU 47 resulting from the execution of these programs 100 to 600 includes two operation modes based on a broad categorization. The two operation modes are the operation mode when the wireless communication section 7 is communicative and the operation mode when the wireless communication section 7 is incommunicative. The CPU 37 and the CPU 47 specify whether or not the wireless communication section 7 is communicative based on whether or not the respective reception power levels indicated by the reception power level signals from the wireless interfaces 35 and 45 are higher than specified reference power levels.

First, the operations for repeating of the CPU 37 and the CPU 47 when the wireless communication section 7 is communicative will be described herein below.

In the execution of the program 100 for downlink reception for data reception from the server 1, the CPU 37 at the wireless base station 3 awaits first at Step 110 till it receives data from the server 1 via the network interface 34.

When the CPU 37 receives the data from the server 1, it subsequently determines at Step 120 whether or not the received data is normal data, i.e., contents data. Data which is not contents data indicates control data for controlling the start and end of a connection, delivery, and the like. More specifically, the control data includes, e.g., SYN data, SYN-ACK data, FIN data, and FIN-ACK data.

When the CPU 37 has received the control data, it then performs at Step 130 normal processing in accordance with the TCP/IP definitions based on the control data. Subsequently, the CPU 37 determines at Step 140 whether or not the communication connection with the server 1 for repeating the contents data from the server 1 to the terminal 6 should be released based on whether the received control data is the FIN data or the FIN-ACK data. In the case of releasing the communication connection with the server 1, the CPU 37 actually releases the connection and ends the execution of the program 100 for downlink reception. In the case of not releasing the connection, the CPU 37 awaits data reception from the server 1 again at Step 110.

When the CPU 37 has received the normal data at Step 120, it then reads the sequence number in the received data (specifically in a TCP segment) and substitutes the value of the sequence number in a variable indicating a transmission ACK number at Step 150. As described above, the packet of the contents data from the server 1 contains therein the sequence number indicating the position in the contents data from which the data in the packet has come. Accordingly, it may be said that the variable indicating the transmission ACK number is a value indicating the total size of the contents data that has been received thus far by the wireless base station 3 for repeating.

Subsequently, at Step 160, the CPU 37 updates a variable indicating the allowable buffer size. The variable indicating the allowable buffer size is used when the ACK data will be transmitted later to the server 1 (see Step 215 in FIG. 7). As will be described later, the variable indicating the allowable buffer size indicates an available capacity in the region for buffering the contents data that has been allocated to the RAM 31 or HDD 33 at the wireless base station 3. Processing at Step 160 will be described later in detail. Subsequently to Step 160, the CPU 37 awaits the reception of data from the server 1 again at Step 110.

As a result of such execution of the program 100 for downlink reception by the CPU 37, when the wireless base station 3 receives the contents data from the server 1, it updates the allowable buffer size which is the current available capacity in the buffer region for the contents data of its own based on the sequence number in the received data. When the CPU 37 receives the control data from the server 1, it performs processing in accordance with the control data.

In the execution of the program 200 for uplink transmission, the CPU 37 determines at Step 205 that the wireless communication section 7 is communicative, as described above. Then, at Step 210, the CPU 37 determines whether or not the variable indicating the transmission ACK number has been updated at Step 150 in the foregoing program 100 for downlink reception after the previous execution of Step 210. The CPU 37 repeats processing at Steps 205 and 210 till the variable is updated. When the variable indicating the transmission ACK number has been updated, it means that contents data has been newly received from the server 1. Accordingly, at Step 215, the CPU 37 subsequently outputs the ACK data designating the server 1 as the destination to the network interface 34. The transmission ACK number to be contained in the ACK data to be outputted is the value of the variable indicating the current transmission ACK number. The allowable buffer size (specifically, the window size) to be contained in the ACK data to be outputted is the value of the variable indicating the current allowable buffer size.

By the foregoing process, the ACK data is delivered from the wireless base station 3 to the server 1. Based on the transmission ACK number and the allowable buffer size in the received ACK data, the server 1 transmits, to the wireless base station 3, data in a range extending from the (Transmission ACK Number+1)-th position (specifically, in the unit of bytes) to the (Transmission ACK Number+Allowable Buffer Size)-th position in the contents data to be transmitted by designating the terminal 6 as the final destination.

In the following description, data in the contents data in a range extending from a position next to the position corresponding to the transmission ACK number contained in a given ACK data item, to the (Transmission ACK Number+Allowable Buffer Size)-th position contained in the given ACK data item will be termed “data in the contents data of which the transmission has been requested by the ACK data item.”

Then, at Step 220, the CPU 37 determines whether or not the communication connection with the server 1 has been released in the program 100 for downlink reception. When the communication connection has been released, the CPU 37 ends the execution of the program 200 for uplink transmission. When the communication connection has not been released, the whole process flow returns to the determination at Step 205.

As a result of such execution of the program 200 for uplink transmission by the CPU 37, every time the wireless base station 3 receives contents data from the server 1 (see Step 210), it transmits to the server 1 the corresponding ACK data including the situation of an available capacity in the buffer of its own (i.e., the state of storage) and the size (corresponding to the transmission ACK number) of the contents data received up to the present (see Step 215).

In the execution of the program 300 for downlink transmission shown in FIG. 8, which is for transferring the received contents data to the wireless mobile station 4 for repeating, the CPU 37 also determines at Step 310 that the wireless communication section 7 is communicative, as described above. Then, at Step 320, the CPU 37 repeats Steps 310 and 320 till it determines that there is contents data to be transmitted to the wireless mobile station 4 at Step 320.

The CPU 37 determines whether or not there is contents data to be transmitted based on whether or not the contents data received from the server 1 includes data of which the transmission has been requested by the latest ACK data received from the wireless mobile station 4 as a result of executing the program 500 for uplink reception of FIG. 10, which will be described later. When there is any data to be transmitted, the CPU 37 then divides the data to be transmitted into packets at Step 330. The CPU 37 outputs the packets to the wireless interface 35 such that they are transmitted by designating the terminal 6 as the final destination and designating the wireless mobile station 4 as a via-point. At the time of contents data transmission, the CPU 37 adds, to each of the packets, the sequence number indicating the position (specifically, a number of order in bytes) in the contents data from which the data in the packet has come.

Subsequently to Step 330, the CPU 37 performs buffering with respect to the contents data at Step 340. Buffering indicates the storage of data in the region for buffering described above. The contents data as the target of buffering is contents data in positions next and subsequent to the position corresponding to the ACK number in the contents data received from the server 1. The ACK number contained in the ACK data from the wireless mobile station 4 will be substituted in the variable indicating a reception ACK number in the execution of Step 550 in the program 500 for uplink reception, which will be described later. However, the CPU 37 does not perform buffering again with respect to data that has already been buffered.

The reason for thus buffering data is that data of which the reception has not been confirmed by the wireless mobile station 4 has the possibility of receiving a retransmission request after it has been transmitted once.

At Step 350 subsequent to Step 340, the CPU 37 determines whether or not the communication connection with the wireless mobile station 4 has been released during the execution of the program 500 for uplink reception, which will be described later. When the communication connection has been released, the CUP 37 ends the execution of the program 300 for downlink transmission. When the communication connection has not been released, the CUP 37 returns to the execution of Steps 310 and 320.

As a result of such execution of the foregoing program 300 for downlink transmission by the CPU 37, the wireless base station 3 transmits to the wireless mobile station 4 the data in the contents data received from the server 1 which is necessary in accordance with the TCP protocols.

The CPU 47 at the wireless mobile station 4 as the receiver of the contents data executes the foregoing program 100 for downlink reception of FIG. 6 as a program for receiving contents data. As a result of such execution of the program 100 for downlink reception by the CPU 47, when the wireless mobile station 4 receives contents data from the wireless base station 3, it causes the sequence number in the received data to be stored as indicating the transmission ACK number and updates the allowable buffer size as a currently available capacity in the region for buffering the contents data of its own based on the sequence number in the received data. When the wireless mobile station 4 receives control data from the wireless base station 3, it performs processing responsive to the control data.

The CPU 47 also performs processing as shown at Steps 405 to 420 in the execution of the program 400 for uplink transmission shown in FIG. 9, which is for transmitting control data to the wireless base station 3. Processing performed herein at Steps 405, 410, 415, and 420 is equal to the processing at Steps 205, 210, 215, and 220 in the program 200 for uplink transmission executed by the CPU 37. However, the destination to which the ACK data is to be transmitted at Step 415 is the wireless base station 3.

As a result of such execution of the program 400 for uplink transmission by the CPU 47, every time the wireless mobile station 4 receives contents data from the wireless base station 3 (see Step 410), it transmits to the wireless base station 3 the corresponding ACK data including the situation of an available capacity in the buffer of its own and the size (corresponding to the transmission ACK number) of the contents data received up to the present (see Step 415).

In the execution of the program 500 for uplink reception shown in FIG. 10, which is for receiving control data from the wireless mobile station 4, the CPU 37 at the wireless base station 3 as the receiver of such ACK data awaits first at Step 510 till it receives control data from the wireless mobile station 4 via the wireless interface 35. When the CPU 37 has received the control data, it subsequently determines at Step 520 whether or not the control data is the ACK data based on the transmission of the contents data from the wireless base station 3 or the other control data such as the SYN, SYN-ACK, FIN, or FIN-ACK.

When the received control data is not the ACK for the contents data, the CPU 37 subsequently performs at Step 530 the same packet processing as performed at Step 130 in the program 100 for downlink reception. Then, at Step 540, when the received control data is the FIN or FIN-ACK, the CPU 37 releases the communication connection with the wireless base station 4 and ends the execution of the program 500 for uplink reception. When the received control data is neither the FIN nor FIN-ACK, the CPU 37 then executes Step 510 again.

When the CPU 37 determines at Step 520 that the received control data is the ACK for the contents data, it subsequently substitutes the value of the ACK number contained in the received ACK data in the variable indicating the reception ACK number at Step 550. The value of the ACK number contained in the received ACK number indicates an amount of the contents data that has been received by the wireless mobile station 4 at the present moment, as described above.

Then, at Step 555, the CPU 37 deletes a part of the buffer. The deleted part is specifically, the contents data at the positions of the value of the variable indicating the current reception ACK number and previous to it. The reason for such deletion is that the data of which the reception has been confirmed by the wireless mobile station 4 need not be buffered any more.

Then, at Step 160, the CPU 37 updates the allowable buffer size in the same manner as at Step 160 in the program 100 for downlink reception. FIG. 11 shows a detailed flow chart for the process of updating the variable indicating the allowable buffer size.

As shown in FIG. 11, in the process of updating the variable indicating the allowable buffer size, the CPU 37 subtracts the variable indicting the current reception ACK number from the variable indicating the current transmission ACK number and determines whether or not the result of the subtraction is smaller than a given data size M (Step 162). When the result of the subtraction is smaller than the given data size M, the CPU 37 substitutes a value obtained by subtracting the result of the subtraction from the size M in the variable indicating the allowable buffer size (Step 164). When the result of the subtraction is as large as or larger than the data size M, the CPU 37 substitutes zero in the variable indicating the allowable buffer size (Step 166).

The data size M mentioned herein is the maximum capacity of the region for buffering contents data that has been allocated to the RAM 31 or HDD 33 at the wireless base station 3. Accordingly, the variable indicating the allowable buffer size has a value indicating an available capacity in the region for buffering contents data.

Thus, the value of the variable indicating the allowable buffer size is reduced by the execution of Step 160 in the program 100 for downlink reception when the contents data has been received from the server 1. Conversely, the value of the variable indicating the allowable buffer size is increased by the execution of Step 160 in the program 500 for uplink reception when the ACK data has been received from the wireless base station 3.

In the execution of the program 600 for downlink transmission of FIG. 12, which is for transmitting the contents data received from the wireless base station 3 for repeating, the wireless mobile station 4 determines at Step 610 that the wireless communication section 7 is communicative, as described above, and subsequently executes Steps 620 through 650. Processing performed herein at Steps 620, 630, 640, and 650 is equal to the processing performed at Steps 320, 330, 340, and 350 in the program 300 for downlink transmission shown in FIG. 8. The difference is that the target of transmission/reception is the terminal 6 in the program 600 for downlink transmission, while the target of transmission/reception is the wireless mobile station 4 in the program 300 for downlink transmission.

As a result of such execution of the program 600 for downlink transmission by the CPU 47, the wireless mobile station 4 transmits to the terminal 6 the data in the contents data transmitted from the server 1 and received from the wireless base station 3 which is necessary in accordance with the TCP protocols.

Thus, in the state in which the wireless communication section 7 is communicative, the server 1 transmits contents data to the wireless base station 3 and the wireless base station 3 transmits the ACK data to the server 1 based on the reception of the contents data; whereby the reception/transmission of the contents data proceeds between the server 1 and the wireless base station 3. On the other hand, the wireless base station 3 transmits the contents data to the wireless mobile station 4 and the wireless mobile station 4 transmits the ACK data to the wireless base station 3 based on the reception of the contents data; whereby the reception/transmission of the contents data proceeds between the wireless base station 3 and the wireless mobile station 4. In addition, the wireless mobile station 4 transmits the contents data to the terminal 6 and the terminal 6 transmits the ACK data to the wireless mobile station 4 based on the reception of the contents data; whereby the reception/transmission of the contents data proceeds between the wireless mobile station 4 and the terminal 6. Thus, the contents data is repeated successively from the server 1 to the wireless base station 3, from the wireless base station 3 to the wireless mobile station 4, and from the wireless mobile station 4 to the terminal 6, while the server 1 and the wireless base station 3, the wireless base station 3 and the wireless mobile station 4, and the wireless mobile station 4 and the terminal 6 establish respective TCP connections therebetween such that each of the TCP connections is independent of the others and perform the reception/transmission of the data. The server 1 continues to determine that the connection with the terminal 6 is continuing by receiving the ACK data from the mobile base station 3. In contrast, the terminal 6 continues to determine that the connection with the server 1 is continuing by receiving the contents data from the wireless mobile station 4.

A description will be given next to the operation of the communication repeater system when communication in the wireless communication section 7 is disabled. In this case, each of the wireless base station 3 and the wireless mobile station 4 has been adapted to periodically transmit, to the server 1 and the terminal 6, camouflage data for causing the server 1 and the terminal 6 to determine that the connection for data communication therebetween is continuing. A specific description will be given herein below to the operation at this time.

In this case, the CPU 37 at the wireless base station 3 executes the program 100 for downlink reception in the same manner as in the case where the wireless communication section 7 is communicative. In the program 300 for downlink transmission, the CPU 37 continues to determine at Step 310 that the wireless communication section 7 is incommunicative. In the program 500 for uplink reception, the CPU 37 continues to determine at Step 510 that there is no data reception since the wireless communication section 7 is incommunicative.

In the execution of the program 200 for uplink transmission, the CPU 37 determines at Step 205 that the wireless communication section 7 is incommunicative and subsequently starts a timer for measuring an elapsed time from 0 at Step 225.

Then, at Step 230, the CPU 37 determines that the wireless communication section 7 is incommunicative and subsequently determines at Step 235 whether or not the timer mentioned above has expired. The expiry of the timer indicates that the time measured by the timer has elapsed over a given expiry period (e.g., 1 minute). The given expiry period is a sufficiently long period not to give a significant influence, such as convergence, to the wired network 2 due to an increase in the amount of ACK transmission and is a sufficiently short period to prevent the determination that the connection between the server 1 and the terminal 6 has been closed based on the fact that the server has not received the ACK data for a period not shorter than a time-out period. The given value may be a fixed value or, alternatively, the wireless base station 3 may adjust the expiry period to the time-out period through a procedure in which, e.g., the wireless base station 3 requests data on the time-out period from the server 1 and the server 1 transmits the data on the time-out period to the wireless base station 3 in response to the request. When the timer has expired, the CPU 37 subsequently executes Step 240. When the timer has not expired, the CPU 37 subsequently performs Steps 230 and 235.

At Step 240 after the expiry of the timer, the CPU 37 outputs the ACK data to the network interface 34 such that it is transmitted to the server 1. The ACK number and the allowable buffer size each to be contained in the ACK data to be transmitted is the value of the variable indicating the current transmission ACK number and the value of the variable indicating the current allowable buffer size in the same manner as at Step 215.

Subsequently to Step 240, the timer is ended at Step 255 and it is determined at Step 220 whether or not the communication connection has been released, as described above. When the communication connection has not been released, the CPU 37 subsequently executes Steps 205 and 225. When the communication connection has been released, the CPU 37 ends the execution of the program 200 for uplink transmission.

When the wireless base station 3 determines that the wireless communication section 7 is incommunicative as a result of such operation by the CPU 37, it repeats the transmission of the ACK data to the server 1 ever time the expiry period has elapsed. As described above, the server 1 determines that the communication connection with the terminal 6 is continuing as long as it continues to receive the ACK data from the wireless base station 3 at intervals shorter than time-out intervals so that the server 1 does not end processing for the transmission of contents data. In that sense, the ACK data as the control data transmitted from the wireless base station 3 to the server 1 when the wireless communication section 7 is incommunicative is camouflage data for causing the server 1 to determine that the data communication between itself and the terminal 6 is continuing. When the wireless communication section 7 remains incommunicative for a long period (e.g., 1 hour), the wireless base station 3 may also stop the transmission of the camouflage data to the server 1.

As described above, the value of the variable indicating the transmission ACK number is increased by the execution of Step 150 in the program 100 for downlink reception upon the reception of the contents data from the server 1. On the other hand, the value of the variable indicating the allowable buffer size decreases upon the reception of the contents data from the server 1 and decreases upon the reception of the ACK data from the wireless mobile station 4. Accordingly, when the wireless communication section 7 is incommunicative, there is no reception of the ACK data from the wireless mobile station 4. Therefore, every time the contents data is received from the server 1, the value of the variable indicating the transmission ACK number continues to increase and the value of the variable indicating the allowable buffer size continues to decrease.

When the value of the variable indicating the allowable buffer size has become zero and thereafter, the ACK data in which the allowable buffer size is zero is transmitted to the server 1 every time the expiry period has elapsed so that the server 1 does not end the processing for transmission. In addition, the transmission of contents data comes in a standby state so that the value of the variable indicating the transmission ACK number does not change at the wireless base station 3. Thus, when the value of the variable indicating the allowable buffer size has become zero and thereafter, the allowable buffer size and the ACK number in the transmitted ACK do not change as long as the wireless communication section 7 is incommunicative.

When the wireless communication section 7 is incommunicative, the wireless mobile station 4 continues to determine at Step 110 that there is no data reception from the wireless base station 3 in the program 100 for downlink reception. At Step 405 in the program 400 for uplink transmission, the wireless mobile station 4 continues to determine that the wireless communication section 7 is incommunicative. In the program 500 for uplink reception, the wireless mobile station 4 performs the same processing as in the case where the wireless communication section 7 is communicative.

In the execution of the program 600 for downlink transmission, the wireless mobile station 4 determines first at Step 610 that the wireless communication section 7 is incommunicative and then determines at Step 655 whether or not there is any contents data buffered in the region for buffering. When there is any, the wireless mobile station 4 performs the transmission and buffering of the data at Steps 630 to 650 described above and executes Steps 610 and 655 again until the connection is released.

When there is no buffered contents data, the wireless mobile station 4 subsequently starts the timer for measuring the elapsed time from 0 at Step 660. Then, at Step 665, the wireless mobile station 4 determines that the wireless communication section 7 is incommunicative. Then, at Step 670, the wireless mobile station 4 determines whether or not the timer has expired. When the timer has not expired, the wireless mobile station 4 subsequently executes Steps 665 and 670 again. The determination of whether or not the timer has expired is the same as at Step 235 in the program 200 for uplink transmission.

When the timer has expired, the wireless mobile station 4 then ends the timer at Step 675 and outputs camouflage data to the network interface 44 at Step 680 such that it is transmitted to the terminal 6. As the camouflage data, any data may be used provided that it can cause the terminal 6 to determine that the data communication between the terminal 6 and the server 1 is continuing. The camouflage data may be, e.g., a packet having exactly the same transmission ACK number and content (payload) as the last contents data packet transmitted to the terminal 6. The camouflage data may also be contents data which has a random content and may cause a failure in a received data consistency check (e.g., a check-sum check) in the reception at the terminal 6. The data illustrated above can be termed false data since it is data which should not inherently be delivered.

Subsequently to Step 680, the wireless mobile station 4 determines at Step 650 whether or not the communication connection has been released, as described above. When the communication connection has not been released, the wireless mobile station 4 subsequently executes Steps 610 and 655. When the communication connection has been released, the wireless mobile station 4 ends the execution of the program 600 for downlink transmission.

With this being the situation, when the wireless communication section 7 is incommunicative, when there is any buffered contents data, the wireless mobile station 4 transmits the buffered contents data to the terminal 6. When there is no more buffered data, the wireless mobile station 4 repeatedly transmits the camouflage data to the terminal 6 every time the timer expiry period has elapsed. With this being the situation, the terminal 6 determines that the data communication with the server 1 is continuing provided that it continues to receive the camouflage data at intervals shorter than the time-out intervals. Accordingly, the terminal 6 does not end processing for reception. The wireless mobile station 4 may also stop the transmission of the camouflage data to the terminal 6 when the wireless communication section 7 remains incommunicative for a long period (e.g., 1 hour).

A description will be given next to the case where the wireless communication section 7 has shifted from the incommunicative state to the communicative state. At this time, in the execution of the program 200 for uplink transmission, the CPU 37 at the wireless base station 3 determines at Step 230 that the wireless communication section 7 is communicative. Then, at Step 245, the CPU 37 outputs the ACK data to the network interface 34 such that it is transmitted to the server 1 in the same manner as at Step 215. Then, at Step 250, the CPU 37 determines whether or not the variable indicating the transmission ACK number has been updated in the same manner as at Step 210. When the variable has been updated, the CPU 37 ends the timer at Step 255. Unless the communication connection is released, the CPU 37 subsequently executes Steps 220, 205, and 210 and returns to the operation in the normal state where the wireless communication section 7 is communicative. When the variable indicating the transmission ACK number has not been updated, the CPU 37 executes Steps 230 and 245 again.

With this being the situation, when the wireless communication section 7 has recovered to the communicative state, the CPU 37 repeatedly transmits the ACK data to the server 1 without awaiting the expiry of the timer. Accordingly, the cycle of ACK data transmission becomes shorter than when the wireless communication section 7 was incommunicative.

This allows prompt notification to the server 1 that the recovery of the wireless communication section 7 has resumed the transmission of contents data from the wireless base station 3 to the wireless mobile station 4 (Step 330 in the program 300 for downlink transmission) and that the value of the allowable buffer size increases from zero at the wireless base station 3 (Step 160 in the program 500 for uplink reception). As a result, the server 1 can promptly resume the transmission of contents data.

When the data the transmission of which is requested first from the server 1 upon the recovery of the wireless communication section 7 is retransmitted data, i.e., when the CPU 37 transmits the ACK data containing the ACK number corresponding to the contents data once transmitted from the server 1, it is defined in the normal TCP standards that the server 1 actually retransmits the contents data only when the server 1 has received the data the retransmission of which is requested three or more times. In this case also, when the CPU 37 repeatedly transmits the ACK in a shorter cycle, the retransmission of the contents data from the server 1 begins promptly.

When the wireless communication section 7 has shifted from the incommunicative state to the communicative state, in the execution of the program 600 for downlink transmission, the CPU 47 at the wireless mobile station 4 determines at Step 665 that the wireless communication section 7 has become communicative. Then, at Step 675, the CPU 47 ends the timer and transmits camouflage data at Step 680. Unless the communication connection is released, the CPU 47 subsequently executes Steps 650, 610, and 620 and returns to the operation in the normal state where the wireless communication section 7 is communicative.

When the wireless communication section 7 comes into the incommunicative state and then recovers to the communicative state, each of the server 1 and the terminal 6 preferably has the same IP address. As a method for implements this, the server 1 and the terminal 6 may also have fixed IP addresses unless there is a change in a segment to which the base station connected to the terminal 6 belongs before or after the wireless communication section 7 becomes incommunicative. When a dynamic IP address is allocated to the terminal 6 for wireless connection in the wireless communication section 7, the following may be designed: When wireless connection is established again in the wireless communication section 7, a device for allocating the address may store identification information for the terminal 6 and the IP address used thereby such that the same IP address as used before the closing of the wireless communication is imparted based on the stored information.

When the mobile IP technology in accordance with the IPv6 standards is used, even in the case where there is a change in the IP address of the terminal 6 before or after the wireless communication section 7 becomes incommunicative, the communication between the server 1 and the terminal 6 continues.

In the above embodiment, a server 1 (located upstream or uplink) and a terminal 6 (located downstream or downlink) function as communication units to communicate with each other via a communication path. The communication path includes: a wireless base station 3 and a wireless mobile station 4 functioning as communication repeaters; a communication circuit including network interfaces 34, 44 and wireless interfaces 35, 45; wired networks 2, 5; and a wireless communication section 7. Further, CPUs 37, 47 of the wireless base station 3 and the wireless mobile station 4 function as transmission control units or repeating units by executing various programs.

Although the wireless base station 3 and the wireless mobile station 4 have transmitted the camouflage data (i.e., the ACK data at Step 240 and the camouflage data at S680) to the server 1 and the terminal 6 in the embodiment described above, the wireless base station 3 may also transmit the camouflage data only to the server 1 or only the wireless mobile station 4 may transmit the camouflage data to the terminal 6. In this case, either the server 1 determines that the data communication between itself and the terminal 6 is continuing or the terminal 6 determines that data communication between itself and the server 1 is continuing, but nevertheless, a steady effect is achieved.

Although the embodiment described above has shown the TCP/IP protocols as an example of communication protocols in the communication repeater system, this is only illustrative. It is not necessary to follow either the TCP protocols or the IP protocols.

Although the embodiment described above has specified whether or not the wireless communication section 7 is communicative based on whether or not the reception power level signal is higher than the specified reference power level, the specification can also be performed therebetween based on a bit error rate or a packet error rate.

Alternatively, the wireless mobile station 4 and the terminal 6 may also be integrated as a single device (e.g., a navigation device for a vehicle or a mobile telephone) and data may also be exchanged via a signal line in the device.

In the embodiment described above, the CPUs 37 and 47 at the wireless base station 3 and the wireless mobile station 4 have determined that the wireless communication section 7 is incommunicative and transmitted the camouflage data only when it is incommunicative. However, either of the wireless base station 3 and the wireless mobile station 4 need not necessarily have the function of judging that the wireless communication section 7 is incommunicative. For example, the wireless base station 3 and the wireless mobile station 4 may also transmit the camouflage data constantly and repeatedly at specified intervals regardless of whether or not the wireless communication section 7 is incommunicative.

Although the camouflage data transmitted from the wireless base station 3 to the server 1 has been the ACK data, the camouflage data need not necessarily be the ACK data. Any data may be used as the camouflage data provided that it causes the server 1 to determine that the data communication between itself and the terminal 6 is continuing.

The communication repeater and the upstream communication repeater need not necessarily be implemented as the wireless base station 3 as described in the foregoing embodiment. It is also possible for a communication unit other than the wireless base station 3 connected to the wired network 2 to implement the functions of the communication repeater and the upstream communication repeater.

When the server 1 is connected to a broadband network such as the Internet, e.g., a router for repeating communication between a base station network to which multiple wireless base stations including the wireless base station 3 are connected and a broadband network such as the Internet may implement the functions as the communication repeater and the upstream communication repeater. For this purpose, the CPU of the router may be adapted appropriately to execute the program 100 for downlink reception, the program 200 for uplink transmission, the program 300 for downlink transmission, and the program 500 for uplink reception.

In that case, in the execution of each of the programs by the CPU, the determination of whether or not the wireless communication section is communicative may be performed appropriately based on information on whether or not the wireless communication section is communicative for each of the wireless base stations, which is transmitted from each of the wireless base stations in the base station network to the router. More specifically, the CPU may appropriately determine that the wireless communication section is incommunicative when the wireless communication section is incommunicative for all of the wireless base stations in the base station network and may appropriately determine that the wireless communication section is communicative when the wireless communication section is communicative for at least one of the wireless base stations in the base station network.

Likewise, the communication repeater and the downstream communication repeater need not necessarily be implemented as the wireless mobile station 4 as described in the foregoing embodiment. It is also possible for a communication unit other than the wireless mobile station 4 connected to the wired network 5 to implement the functions of the communication repeater and the downstream communication repeater by executing the program 100 for downlink reception, the program 400 for uplink transmission, the program 500 for uplink reception, and the program 600 for downlink transmission. In that case, the determination of whether or not the wireless communication section is communicative may be performed appropriately based on information on whether or not the wireless communication section is communicative for the wireless mobile station 4, which is transmitted from the wireless mobile station 4 to the other communication unit.

It will be obvious to those skilled in the art that various changes may be made in the above-described embodiments of the present invention. However, the scope of the present invention should be determined by the following claims.

What is claimed is:

1. A communication repeater comprising:
a communication circuit;
a repeating unit for repeating data communication between a first communication unit and a second communication unit by using the communication circuit; and
a transmission control unit for repetitively transmitting, to the first communication unit and by using the communication circuit, camouflage data for causing the first communication unit to determine that the data communication between the first communication unit and the second communication unit is continuing when communication is disabled in a wireless communication section between the second communication unit and the communication repeater to which the transmission control unit belongs.

2. A communication repeater according to claim 1,
wherein the camouflage data repetitively transmitted from the transmission control unit is response data to the data transmitted from the first communication unit.

3. A communication repeater according to claim 1,
wherein the repeating unit repeats the data communication of contents data from the second communication unit to the first communication unit, and
wherein the camouflage data repetitively transmitted from the transmission control unit relates to the contents data.

4. A communication repeater according to claim 1, further comprising:
a memory medium for storing, as buffered data, data received from the first communication unit till the second communication unit receives the data,
wherein the camouflage data repetitively transmitted from the transmission control unit includes a state of storage of the buffered data in the memory medium.

5. A communication repeater according to claim 4,
wherein, when the wireless communication section is shifted from an incommunicative state to a communicative state, the transmission control unit transmits the camouflage data to the first communication unit at a repetition interval shorter than an interval between repetitive transmissions of the camouflage data when communication is disabled in the wireless communication section.

6. A computer program product in a computer-readable medium in use for a communication repeater, the computer program product comprising:
instruction for repeating data communication between first and second communication units; and
instruction for transmitting repetitively, to the first communication unit, given data for causing the first communication unit to determine that the data communication between the first and second communication units is continuing when communication is disabled in a wireless communication section between the second communication unit and the communication repeater.

7. A communication repeater system comprising:
an upstream communication repeater; and
a downstream communication repeater,
wherein the upstream communication repeater has:
an upstream communication circuit; and
an upstream repeating unit for receiving, by using the upstream communication circuit, contents data transmitted from a server device to be delivered to a client device and transmitting the received contents data to the downstream communication repeater via a wireless communication section,
wherein the downstream communication repeater has:
a downstream communication circuit; and
a downstream repeating unit for receiving, by using the downstream communication circuit, the contents data transmitted from the upstream communication repeater via the wireless communication section and transmitting the received contents data to the client device,
wherein the upstream communication repeater further has:
an upstream transmission control unit for repetitively transmitting, to the server device and by using the upstream communication circuit, first data for causing the server device to determine that the transmission of the contents data from the server device to the client device is continuing when communication is disabled in the wireless communication section, and
wherein the downstream communication repeater further has:
a downstream transmission control unit for repetitively transmitting, to the client device and by using the downstream communication circuit, second data for causing the client device to determine that the transmission of the contents data from the server device to the client device is continuing when communication is disabled in the wireless communication section.
